(19) United States
(12) Patent Application Publication
(10) Pub. No.: US 2006/0117880 A1
(43) Pub. Date: Jun. 8, 2006

(54) Drive device comprising a roll body screw

(76) Inventor: Jurgen Osterlanger, EMSKIRCHEN (DE)

Correspondence Address: LUCAS & MERCANTI, LLP, 475 PARK AVENUE SOUTH, 15TH FLOOR, NEW YORK, NY, 10016, US

(21) Appl. No.: 10/538,908

(22) PCT Filed: Nov. 20, 2003
(86) PCT No.: PCT/EP03/12969

§ 371 Date: Jun. 14, 2005

(30) Foreign Application Priority Data
Dec. 17, 2002 (DE) 102 58 826.0

(51) Int. Cl. F16H 25/22

(52) U.S. Cl. 74/89.23

(57) ABSTRACT

Drive device (1), with a rolling-body screw mechanism (11, 12), in whose housing divided into two housing parts (2, 3) transversely to the axis of rotation a hollow rotor (6) is mounted rotatably by means of a rolling mounting (12, 25), through which rotor (6) a threaded spindle (20, 28) of the rolling-body screw mechanism (11, 22) is led, the threaded spindle (20, 28) being mounted rotatably on a spindle nut (10, 27) of the rolling-body screw mechanism (11, 22), the said spindle nut being drive-connected to the rotor (6), the rolling mounting (11, 22) being provided on only one housing part (3) of the housing (2).

The present invention relates to a drive device with a rolling-body screw mechanism. EP 0 814 012 A1, for example, has disclosed a drive device for the steering of a motor vehicle. Electromechanical drive devices of this type are often designated as steer-by-wire devices. The known drive device has a housing which is divided into two housing parts transversely to the axis of rotation and in which is arranged a hollow rotor which is part of an electric motor. A threaded spindle partially designed as a rack is led through the rotor. The rotor is drive-connected to a spindle nut of the ball screw mechanism via a torque limiter, the threaded spindle being led through the spindle nut. The spindle nut is rotatably mounted at each of its two axial ends on the housing via a grooved ball bearing, one grooved ball bearing being seated in one housing part and the other grooved ball bearing being seated in the other housing part.

In ball screw mechanisms, the spindle nut should be arranged satisfactorily with respect to the threaded spindle, in order to avoid undesirably high friction or even a jamming of the balls between the threaded spindle and the spindle nut. In the present exemplary embodiment, therefore, the two bearing seats of the two housing parts, on the one hand, and the screw connections of the two housing parts to one another, on the other hand, have to be coordinated exactly with one another. The object of the present invention is to specify a drive device according to the features of the precharacterizing clause of claim 1, in which a satisfactory seat of the spindle nut is ensured.

This object is achieved, according to the invention, in that the rolling mounting is provided on only one housing part of the housing. It is no longer necessary to coordinate the bearing seats of the two housing parts with one another. The screw connection of the two housing parts to one another is also correspondingly simplified. The rolling mounting may be formed by rolling bearings which are arranged at both ends of the spindle nut. To ensure a mounting which is flexible or has a short build in the axial direction, however, it is advantageous to provide a one-sided rolling mounting of the spindle nut.

Preferably, the rolling mounting is formed by a multi-row angular ball bearing, the outer ring of which is seated in a housing bore of one of the housing parts. In this development according to the invention, the spindle nut can easily be mounted on the one housing part via the multi-row angular ball bearing. The outer ring of the angular ball bearing may, for example, be pressed into or otherwise secured in the housing bore. Premounted structural units can thereby be assembled, and the drive device according to the invention can be completed in a simple way by the addition of the other housing part.

According to the invention, preferably, two-row angular ball bearings are provided, the two ball rows of which may be arranged both in an O- and in X-arrangement. An O-arrangement will be preferred when a particularly rigid mounting of the spindle nut is to be ensured. An X-arrangement may be suitable when increased flexibility of the spindle nut is to be ensured.

The premounted structural unit can be extended by the rotor being placed onto the spindle nut. The rotor can be assembled as a separate part together with the spindle nut fixedly in terms of rotation, but it is also conceivable for the rotor of the spindle nut to be produced in one piece with one another.

To reduce the overall radial height, in the development according to the invention, ball grooves for balls of the angular ball bearing are formed on the outer circumference of the spindle nut. A separate inner ring with ball grooves is dispensed with.

To reduce the axial overall space requirement, in a development according to the invention, the rotor is arranged axially within construction space occupied by the spindle nut. For this purpose, the rotor may, for example, have a sheet-metal hub, into which, for example, the spindle nut is pressed.

Likewise in order to reduce the axial overall space requirement, in another development according to the invention, the rolling mounting is arranged axially within a construction space occupied by the spindle nut.

If a ball screw mechanism with outer deflection, known per se, for the balls is used as a rolling-body screw mechanism, it is appropriate, for a drive device in which overall space is saved in the axial direction, to provide the spindle nut, in a region radially between the threaded spindle and the rolling mounting, with a return bore for the balls of the ball screw mechanism. Although the radial overall space requirement is increased slightly due to the outer deflection, nevertheless an arrangement in which the outer deflection is arranged axially next to the spindle nut is avoided.

The invention is explained in more detail below with reference to three exemplary embodiments illustrated in a total of three figures in which:

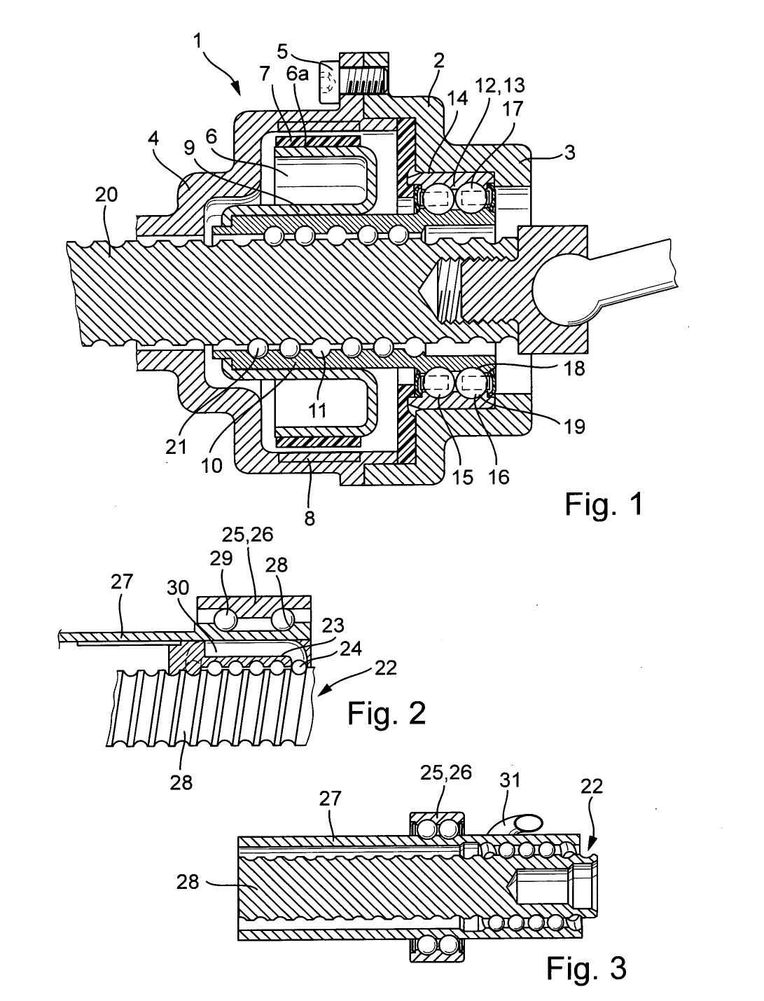

FIG. 1 shows a longitudinal section through a drive device according to the invention,

FIG. 2 shows a longitudinal section through a further drive device according to the invention, and without a housing, and

FIG. 3 shows a longitudinal section through a further drive device according to the invention, but without a housing.

FIG. 1 shows, in longitudinal section, a drive device 1 according to the invention with a ball screw mechanism 11. A housing 2 comprises two housing parts 3, 4 divided transversely to the axis of rotation of the ball screw mechanism 11. The two housing parts 3, 4 are screwed together by means of screws 5. A rotor 6 is equipped circumferentially with a driving surface 6a for a belt 7. The belt 7 is driven by an electric motor, not depicted. The rotor 6 has a hub 9, into which is pressed a spindle nut 10 of a ball screw mechanism 11. The spindle nut 10 is rotatably mounted at one axial end on the housing 2 via a two-row angular ball bearing 12, an outer ring 13 of the angular ball bearing 12 being seated in a housing bore 14 of the housing part 3. The two-row angular ball bearing 12 has two ball rows 15, 16, ball contacts of the two rows being in an O-arrangement with respect to one another. Balls 17 of the two ball rows 15, 16 roll on ball grooves 18, 19, the ball grooves 18 being formed on the outer circumference of the spindle nut 10, and the ball grooves 19 being formed on the inner circumference of the outer ring 13.

The abovementioned ball screw mechanism 11 includes a threaded spindle 20 which is led through the spindle nut 10 and which, furthermore, passes through the housing 2. Balls 21 of the ball screw mechanism 11 are arranged in a known way between the spindle nut 10 and the threaded spindle 20.

The ball screw mechanism 11 is mounted, together with the rotor 6, on one housing part 3. The other housing part 4 can easily be assembled by means of the said screws to form the housing 2, without the risk that undesirable distortions in the ball screw mechanism 11 occur on account of errors of alignment during the screw connection.

Since the rotor 6 is arranged with its driving surface 6a axially within a construction space occupied by the spindle nut 10, the drive device according to the invention advantageously has a short build in the axial direction.

Whereas, in the drive device according to the invention, as shown in FIG. 1, a ball screw mechanism with inner deflection, not illustrated in any more detail, is used, according to FIG. 2 a ball screw mechanism 22 is provided with outer deflection 23 for balls 24. This figure shows only the ball screw mechanism 22 with a double-row angular ball bearing 25 provided according to the invention. As in the exemplary embodiment described in the introduction, the outer ring 26 of the angular ball bearing 25 is arranged in a housing bore of one housing part. As in the exemplary embodiment described above, the rotor is arranged on a spindle nut 27 of the ball screw mechanism 22, although this is not depicted here. In the drive device according to the invention, as shown in FIG. 2, the double-row angular ball bearing 25 is advantageously arranged within a construction space occupied by the spindle nut, so that the axial overall space requirement of the drive device according to the invention is reduced. The spindle nut 27 is likewise provided on its outer circumference with ball grooves 28 for balls 29 of the double-row angular ball bearing 25. The spindle nut 27 is provided between its outer and inner circumference with a return bore 30 for the balls 24 of the ball screw mechanism 22 in order to form the outer deflection 23.

The drive device according to the invention, as shown in FIG. 3, differs from that of FIG. 2 essentially in that the double-row angular ball bearing 25 is arranged axially next to an outer deflection 31 of the ball screw mechanism 22. In this arrangement, the radial overall space requirement is reduced. As in the preceding exemplary embodiments, the outer ring 26 of the double-row angular ball bearing 25 is seated in the housing bore of the housing part 3. As in the preceding exemplary embodiments, the rotor is arranged on the spindle nut 27, although this is not illustrated in any more detail here.

Drive devices according to the invention are suitable particularly for use as steer-by-wire devices in motor vehicles, since the one-sided mounting of the spindle nut rules out undesirable stresses in the rolling-body screw mechanism on account of errors in alignment of the housing parts. Drive devices according to the invention can therefore satisfy the high requirements demanded of a safety part.

### LIST OF REFERENCE NUMERALS

1 Drive device
2 Housing
3 Housing part
4 Housing part
5 Screw
6 Rotor
6a Driving surface
7 Belt
8
9 Hub
10 Spindle nut
11 Ball screw mechanism
12 Angular ball bearing
13 Outer ring
14 Housing bore
15 Ball row
16 Ball row
17 Ball
18 Ball groove
19 Ball groove
20 Threaded spindle
21 Ball
22 Ball screw mechanism
23 Outer deflection
24 Ball
25 Angular ball bearing
26 Outer ring
27 Spindle nut
28 Ball grove
29 Ball
30 Return bore
31 Outer deflection

1. Drive device (1), with a rolling-body screw mechanism (11, 12), in whose housing divided into two housing parts (2, 3) transversely to the axis of rotation a hollow rotor (6) is mounted rotatably by means of a rolling mounting (12, 25), through which rotor (6) a threaded spindle (20, 28) of the rolling-body screw mechanism (11, 22) is led, the threaded spindle (20, 28) being mounted rotatably on a spindle nut (10, 27) of the rolling-body screw mechanism (11, 22), the said spindle nut being drive-connected to the rotor (6), characterized in that the rolling mounting (11, 22) is provided on only one housing part (3) of the housing (2).

2. Drive device (1) according to claim 1, in which the rolling mounting is formed by a multi-row angular ball bearing (12, 25), the outer ring (13, 26) of which is seated in a housing bore (14) of one of the housing parts (3).

3. Drive device (1) according to claim 2, in which ball grooves (18, 19, 28) of the angular ball bearing (12, 25) are formed on the outer circumference of the spindle nut (10, 27).

4. Drive device (1) according to claim 1, in which the rolling mounting (25) is arranged axially within a construction space occupied by the spindle nut (27).

5. Drive device (1) according to claim 1, in which the rotor (6) is arranged axially within a construction space occupied by the spindle nut (10).

6. Drive device (1) according to claim 1, in which the rolling-body screw mechanism is a ball screw mechanism (22) with outer deflection (23) for the balls (24).

7. Drive device (1) according to claim 4, in which the rolling body screw mechanism is a ball screw mechanism (22) with outer deflection (23) for balls (24), and
the spindle nut (27) is provided in a region radially between the threaded spindle (28) and the rolling mounting (25) with a return bore (30) for balls (24) of the ball screw mechanism (22).

8. Drive device (1) according to claim 1, in which the rotor (6) is provided on its circumference with a driving surface (6a) for the drive belts (7).
